(19) United States
(12) Patent Application Publication
(10) Pub. No.: US 2016/0204554 A1
(43) Pub. Date: Jul. 14, 2016

(54) CONNECTOR AND CABLE WITH CONNECTOR

(71) Applicant: HITACHI METALS, LTD., Tokyo (JP)

(72) Inventor: Hiroki YASUDA, Mito (JP)

(21) Appl. No.: 14/914,244

(22) PCT Filed: Feb. 28, 2014
(86) PCT No.: PCT/JP2014/055055

§ 371 Date: Feb. 24, 2016

(51) Int. Cl. H01R 13/66; G02B 6/42; H01R 24/40

(52) U.S. Cl. CPC H01R 13/6691; H01R 24/40; G02B 6/4293; H01R 2107/00

(57) ABSTRACT

A connector includes a plurality of pins, a circuit substrate where an electronic component is mounted onto the mounting surface, a connection member for electrically connecting the plurality of pins and the circuit substrate , and a housing for accommodating the circuit substrate and the connection member. The connection member includes a connection substrate section including a first substrate surface to which one end part of the circuit substrate is connected, and a positioning section for positioning the plurality of pins relative to a second substrate surface of the connection substrate section provided on the opposite side of the first substrate surface. The plurality of pins penetrate through the positioning section and are thereby electrically connected in a state where one end surface of each of the plurality of pins faces the second substrate surface of the connection substrate section.

### TECHNICAL FIELD

The present invention relates to a connector and a cable with connector, which are used for, e.g., signal transmission between industrial machines.

### BACKGROUND ART

A conventional connectorized cable is known, which sends/receives signals from/to a device via a connector and transmits the signals through an optical fiber cable (see, e.g., PTL 1).

The conventional connectorized cable (optical transmission device) described in PTL 1 is provided with an optical fiber cable and a connector portion provided at an end of the optical fiber cable. The connector portion has a cylindrical housing, a cable fixing portion for fixing the optical fiber cable, plural pins connected to a device, a resin main body holding the plural pins, an electric circuit board (electric circuit portion) formed of a flexible board, and a light emitting/receiving element.

The electric circuit board is arranged so that the mounting surface thereof is along an axial direction (extending direction) of the plural pins. The plural pins are held in a state that both ends thereof protrude from the main body, so that one end protrudes toward an opening of the housing through which the outside is seen, and the other end protrudes toward the electric circuit board on front and back sides thereof. The other ends of the plural pins are bent so as to sandwich one edge of the electric circuit board from both sides and are soldered to a conductive pattern formed on the electric circuit board.

### CITATION LIST

### Patent Literature

[PTL 1]

JP-A-6-11630

### SUMMARY OF INVENTION

### Technical Problem

In the conventional connectorized cable described in PTL 1, since the pins on the housing opening side relative to the main body are arranged at intervals according to the specification of a device to be connected, the other ends of the plural pins protrude with a predetermined distance therebetween in a direction perpendicular to the electric circuit board. Therefore, soldering of the pins to the conductive pattern formed on the electric circuit board needs to be carried out in a state that the other ends of the pins are bent to reduce the distance between the pins, and it is difficult to precisely position the pins onto the corresponding conductive pattern.

Thus, it is an object of the invention to provide a connector and a cable with connector, with which a plurality of pins can easily be positioned at a connection point provided on a mounting surface of a substrate.

### Solution to Problem

To solve the above-mentioned problems, the invention provides a connector comprising: a plurality of pins; a circuit substrate where an electronic component(a) is mounted on a mounting surface; a connection member for electrically connecting the plurality of pins and the circuit substrate; and a housing for accommodating the circuit substrate and the connecting member, wherein the connection member comprises a connection substrate section including a first substrate surface to which one end part of the circuit substrate is connected and a positioning section for positioning the plurality of pins relative to a second substrate surface of the connection substrate section provided on the opposite side of the first substrate surface, and the plurality of pins penetrate through the positioning section and are thereby electrically connected in a state where one end surface of each of the plurality of pins faces the second substrate surface of the connection substrate section.

To solve the above-mentioned problems, the invention also provides a cable with connector comprising: the connector described above, and a cable that comprises an electric wire(s) comprising a conductor connected to a pin among at least some of the plurality of pins and a sheath covering the electric wire(s).

### Advantageous Effects of Invention

In the connector and the cable with connector of the invention, plural pins can easily be positioned at a connection point provided on a mounting surface of a substrate.

### BRIEF DESCRIPTION OF DRAWINGS

FIG. 1 is a perspective view showing an example configuration of a cable with connector in an embodiment of the present invention in a state of being connected to another device.

FIG. 2 is a perspective view showing the inside of a housing of the cable with connector.

FIG. 3 is a schematic cross sectional view showing a configuration of an optical circuit including optical circuit components and an optical circuit board.

FIG. 4 is a cross sectional view taken along a line A-A of FIG. 1.

FIG. 5 is a plan view showing plural pins and a connection member.

FIG. 6 is a perspective view showing a connection substrate section of the connection member as viewed from a first substrate surface side.

FIG. 7 is a perspective view showing the connection substrate section of the connection member as viewed from a second substrate surface side.

FIG. 8 is a perspective view showing a positioning section of the connection member.

FIG. 9 is a side view showing connection between the plural pins and the connection member and between the circuit substrate and the connection member.

### DESCRIPTION OF EMBODIMENTS

### Embodiment

This cable with connector is a cable with small photoelectric composite connector used for, e.g., industrial machines, etc.

### Configuration of Cable with Connector 1

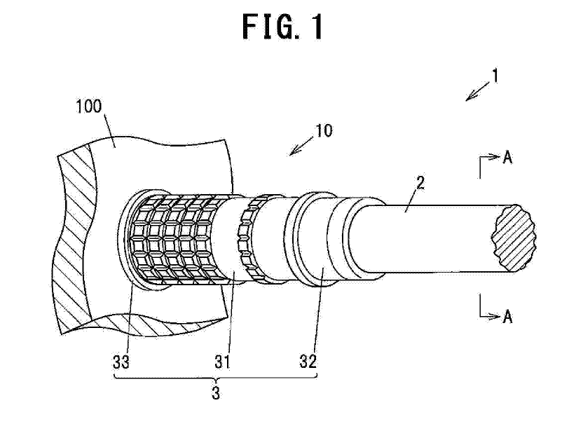

Firstly, the configuration of a cable with connector 1 will be described in reference to FIG. 1.

FIG. 1 is a perspective view showing an example configuration of the cable with connector 1 in an embodiment of the invention in a state of being connected to another device 100.

The cable with connector 1 is provided with a connector 10 to be connected to the other device 100 and a cable 2 having insulated wires and optical fibers (described later).

The connector 10 is provided with a cylindrical housing 3 which has a housing portion 31 for accommodating electronic components (described later), etc., thereinside, a lead-out portion 32 provided on the lead-out side of the cable 2 relative to the housing portion 31, and a flange portion 33 provided on the opposite side to the lead-out portion 32 relative to the housing portion 31.

The flange portion 33 is formed to protrude from the outer periphery of the housing portion 31 so as to be in contact with the other device 100 in a state that the cable with connector 1 is attached to the other device 100.

### Configuration of Connector 10

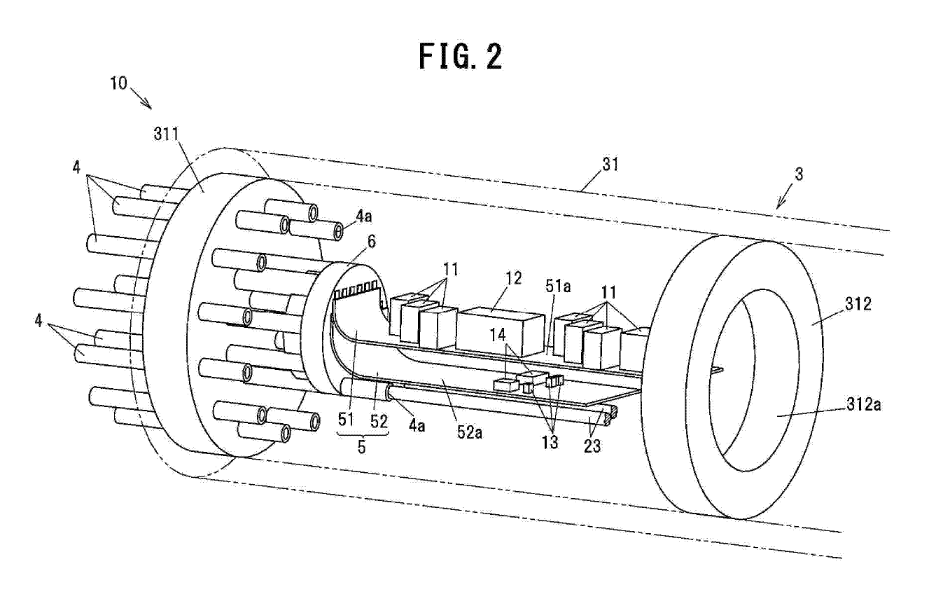

FIG. 2 is a perspective view showing the inside of the housing portion 31 of the housing 3 of the cable with connector 1. The housing portion 31 is simplified and indicated by a dash-dot-dot line in FIG. 2.

The connector 10 is provided with plural (twenty-three in the present embodiment) columnar pins 4 to be connected to the other device 100 (see FIG. 1), a circuit substrate 5 mounting various electronic components, a connection member 6 for electrically connecting the plural pins 4 to the circuit substrate 5, and the housing 3.

In the housing portion 31 of the housing 3, a disc-shaped holding portion 311 for holding the plural pins 4 is provided on one end in the longitudinal direction and a guide portion 312 for guiding the cable 2 (see FIG. 1) toward the lead-out portion 32 is provided on the other end. The guide portion 312 has a ring shape in which an insertion hole 312a for insertion of the cable 2 is formed in the center.

The plural pins 4 penetrate through the holding portion 311 in the thickness direction thereof (in the longitudinal direction of the housing portion 31) so as to protrude, on one end, toward the inside of the housing portion 31 without being bent and to protrude, on the other end, toward the flange portion 33 (see FIG. 1). Therefore, the plural pins 4 are held by the holding portion 311 so that the axial direction thereof is along the longitudinal direction of the housing portion 31.

An insertion hole 4a for insertion and electrical connection of an insulated wire 23 is formed on each pin 4 at the end protruding inside the housing portion 31. In FIG. 2, only some of plural insulated wires 23 are shown and the illustration of the remaining insulated wires 23 is omitted. Here, the plural pins 4 do not necessarily need to be all connected to the insulated wires 23 and, for example, some pins 4 not connected to the insulated wires 23 may be present as spare.

The circuit substrate 5 is composed of an electric circuit board 51 mounting electric circuit components 11 and 12 as electronic components and an optical circuit board 52 mounting optical circuit components 13 and 14 also as electronic components. Then, the circuit substrate 5 is accommodated in the housing portion 31 so that a mounting surface 51a of the electric circuit board 51 mounting the electric circuit components 11 and 12 is parallel to a mounting surface 52a of the optical circuit board 52 mounting the optical circuit components 13 and 14.

In the present embodiment, the electric circuit component 11 is, e.g., a resistor or capacitor, etc., and the electric circuit component 12 is, e.g., a DC-DC converter which converts a supplied direct current of 12V into a direct current of 3.3V. The configuration of an optical circuit including the optical circuit components 13 and 14 will be specifically described below.

### Configuration and Operation of Optical Circuit

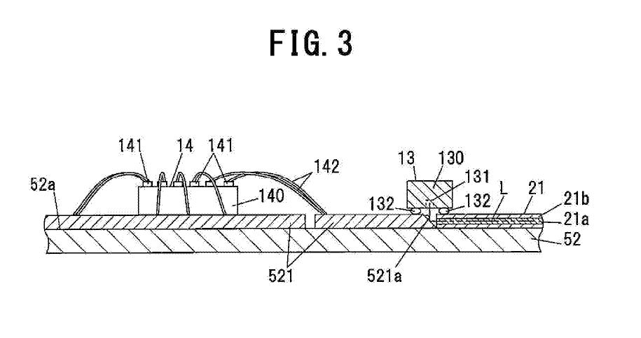

Next, the configuration and operation of the optical circuit will be described in reference to FIG. 3.

FIG. 3 is a schematic cross sectional view showing a configuration of the optical circuit including the optical circuit components 13 and 14 and the optical circuit board 52. In FIG. 3, a light path L passing through an optical fiber 21 is indicated by a dashed-dotted line.

The optical circuit component 13 is, e.g., a photoelectric conversion element which converts an electrical signal into an optical signal or converts an optical signal into an electrical signal. Examples of the former include light-emitting elements such as semiconductor laser element or LED (Light Emitting Diode). Examples of the latter include light-receiving elements such as photodiode. Hereinafter, the optical circuit component 13 will be referred to as the photoelectric conversion element 13.

Meanwhile, the optical circuit component 14 is, e.g., a semiconductor circuit element electrically connected to the photoelectric conversion element 13. Hereinafter, the optical circuit component 14 will be referred to as the semiconductor circuit element 14. When the photoelectric conversion element 13 is a light-emitting element, the semiconductor circuit element 14 is a driver IC for driving the photoelectric conversion element 13.

When the photoelectric conversion element 13 is a light-receiving element, the semiconductor circuit element 14 is a receiver IC for amplifying a signal input from the photoelectric conversion element 13.

The photoelectric conversion element 13 has a main body portion 130 and plural bumps 132 (only two are shown in FIG. 3) provided thereon, and is, e.g., flip-chip mounted on the mounting surface 52a of the optical circuit board 52. Each of the plural bumps 132 is electrically connected to a wiring pattern 521 formed on the mounting surface 52a of the optical circuit board 52. A light-emitting/receiving portion 131 is provided on the main body portion 130 at a position facing the mounting surface 52a of the optical circuit board 52.

The semiconductor circuit element 14 has plural pads 141 (only five are shown in FIG. 3) on a surface of a main body portion 140 opposite to the mounting surface 52a of the optical circuit board 52. The plural pads 141 are electrically connected to the wiring pattern 521 by bonding wires 142. Then, some of the plural pads 141 are connected to the wiring pattern 521 to which the bumps 132 of the photoelectric conversion element 13 are connected, and the semiconductor circuit element 14 is thereby electrically connected to the photoelectric conversion element 13.

The optical fiber 21 has a core 21a and a cladding 21b, and is arranged on the optical circuit board 52 so that one end surface faces a reflective surface 521a formed on the wiring pattern 521. The optical fiber 21, together with the plural insulated wires 23, constitutes the cable 2 (see FIG. 1).

When light is emitted from the core 21a of the optical fiber 21, i.e., when the photoelectric conversion element 13 is a light-receiving element, the emitted light is reflected by the reflective surface 521a toward the photoelectric conversion element 13. The light reflected by the reflective surface 521a is incident on the photoelectric conversion element 13 through the light-emitting/receiving portion 131 of the photoelectric conversion element 13. The photoelectric conversion element 13 converts the incident optical signal into an electrical signal which is then sent to the semiconductor circuit element 14.

When the photoelectric conversion element 13 is a light-emitting element, the photoelectric conversion element 13 converts an electrical signal sent from the semiconductor circuit element 14 into an optical signal which is then emitted from the light-emitting/receiving portion 131. The emitted light is reflected by the reflective surface 521a toward the optical fiber 21. The reflected light is incident on the core 21a of the optical fiber 21 and propagates through the optical fiber 21.

### Configuration of the Cable 2

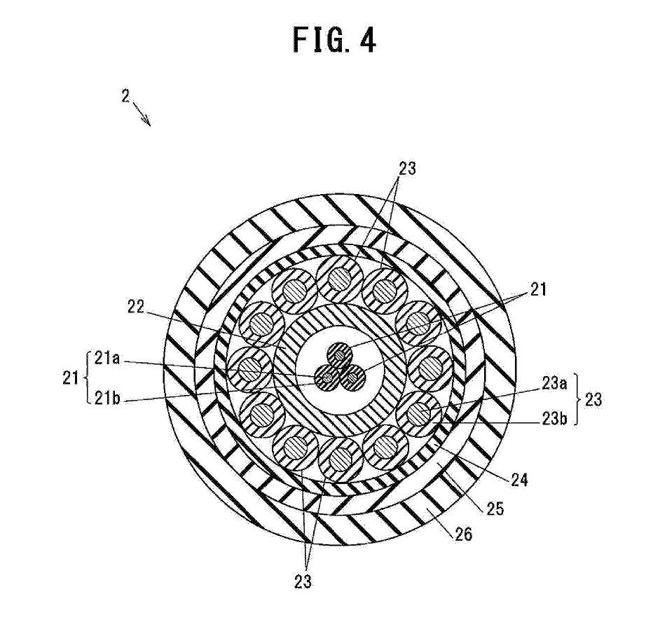

Next, the configuration of the cable 2 will be described in reference to FIG. 4.

FIG. 4 is a cross sectional view taken along the line A-A of FIG. 1.

The cable 2 has plural insulated wires 23 each having a conductor 23a connected to one of at least some of the plural pins 4 (see FIG. 2) and an insulation 23a covering the conductor 23a, and a sheath 26 covering the insulated wires 23. In more detail, it is a photoelectric composite cable in which plural (three in the present embodiment) optical fibers 21 and plural (twelve in the present embodiment) insulated wires 23 are housed inside the sheath 26 which is the outermost layer.

The plural optical fibers 21 are all housed in a protective tube 22 formed of, e.g., a resin such as polyvinyl chloride (PVC). In the present embodiment, there is a space between the plural optical fibers 21 and the protective tube 22.

The plural insulated wires 23 are arranged side-by-side along the outer periphery of the protective tube 22. Some of the plural insulated wires 23 are used as power lines and other insulated wires 23 are used as signal lines for transmitting signals at a lower speed than the transmission speed through the optical fibers 21.

A resin tape 24 formed of a resin, e.g., polyethylene terephthalate (PET), etc., is provided around the plural insulated wires 23. A braided shield 25 is interposed between the resin tape 24 and the sheath 26.

### Configuration of the Connection Member 6

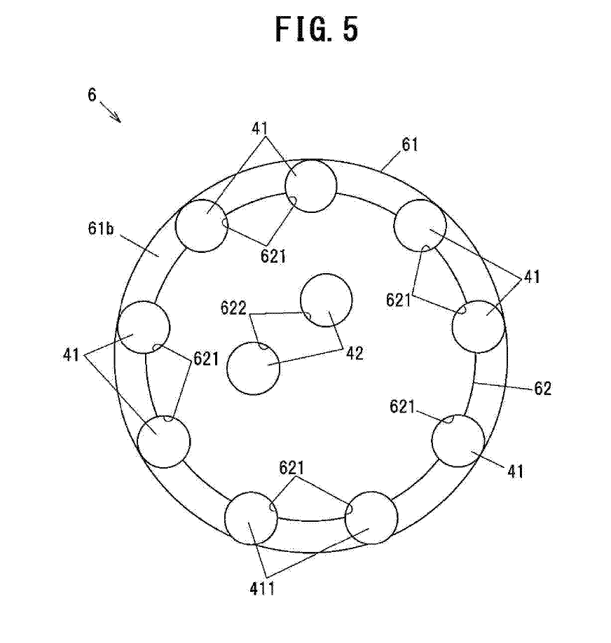

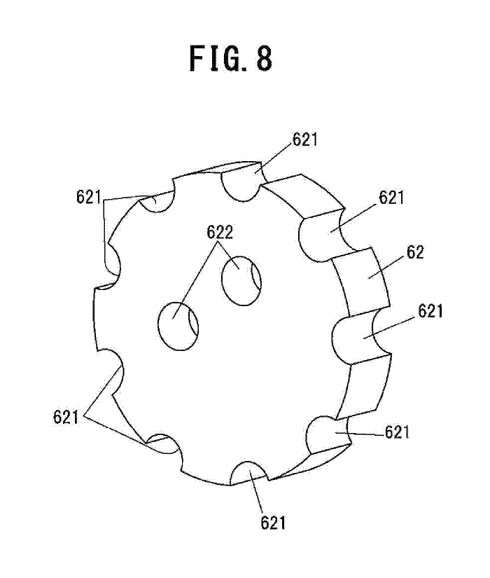

Next, configuration of the connection member 6 will be described in reference to FIGS. 5 and 8.

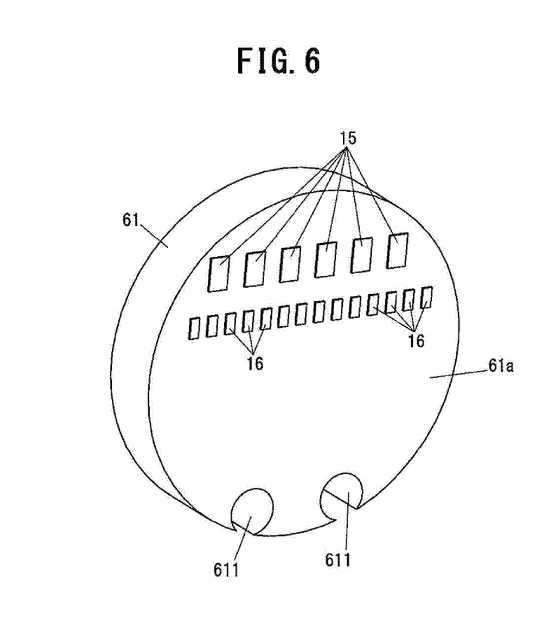

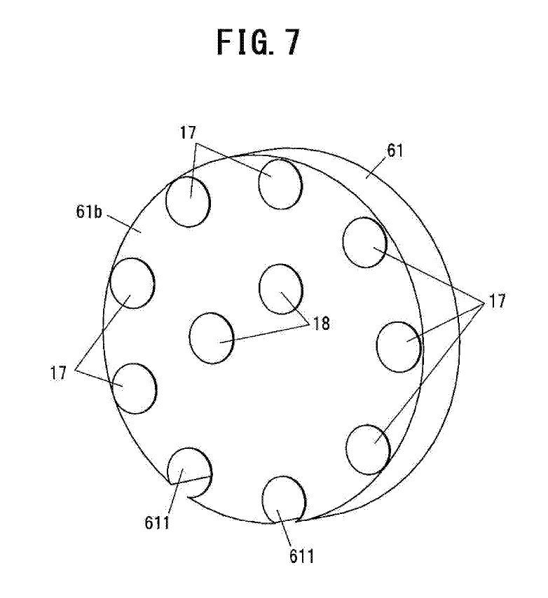

FIG. 5 is a plan view showing the plural pins 4 and the connection member 6. FIG. 6 is a perspective view showing a connection substrate section 61 of the connection member 6 as viewed from a first substrate surface 61a side. FIG. 7 is a perspective view showing the connection substrate section 61 of the connection member 6 as viewed from a second substrate surface 61b side. FIG. 8 is a perspective view showing a positioning section 62 of the connection member 6.

The connection member 6 has the connection substrate section 61 connected to the plural pins 4 as well as to the circuit substrate 5, and the positioning section 62 for positioning the plural pins 4 relative to the connection substrate section 61. In the present embodiment, the connection substrate section 61 is formed of a disc-shaped rigid substrate and is formed to have a larger radial size than the positioning section 62, as shown in FIG. 5. The connection substrate section 61 and the positioning section 62 may be formed integrally or may be formed as separate components.

In the present embodiment, nine of the twenty-three pins 4 are connected to the connection substrate section 61, and then, two of the nine pins 4 are for high-speed signal lines. In the following description, seven of the nine pins 4 excluding the two pins 4 for high speed signal line are referred to as pins 41 and the two pins 4 for high speed signal line are referred to as pins 42.

As shown in FIGS. 6 and 7, the connection substrate section 61 has the first substrate surface 61a provided with plural substrate-connection electrodes 15 and 16 to be connected to the circuit substrate 5 (the electric circuit board 51 and the optical circuit board 52), and the second substrate surface 61b formed on the opposite side to the first substrate surface 61a and provided with plural pin-connection electrodes 17 and 18 to be connected to the plural pins 41 and 42. The first substrate surface 61a faces the circuit substrate 5 (the electric circuit board 51 and the optical circuit board 52), and the second substrate surface 61b is formed on the opposite side to the first substrate surface 61a (on the positioning section 62 side).

One end of the electric circuit board 51 in the longitudinal direction (in an axial direction of the plural pins 41 and 42) is connected to the plural (six in the present embodiment) substrate-connection electrodes 15 and one end of the optical circuit board 52 in the longitudinal direction (in the axial direction of the plural pins 41 and 42) to the plural (fourteen in the present embodiment) substrate-connection electrodes 16 by, e.g., soldering, etc.

The plural substrate-connection electrodes 15 and 16 are arranged to form respective rows in a lateral direction of the electric circuit board 51 and the optical circuit board 52 (a direction perpendicular to the axial direction of the plural pins 41 and 42 as well as parallel to the mounting surfaces 51a and 52a). In the present embodiment, the plural substrate-connection electrodes 15 are arranged on the outer side relative to the plural substrate-connection electrodes 16 in a radial direction of the connection substrate section 61.

The seven pins 41 are connected to the plural (seven in the present embodiment) pin-connection electrodes 17 and the two pins 42 for high speed signal line are connected to the plural (two in the present embodiment) pin-connection electrodes 18. The seven pin-connection electrodes 17 are arranged side-by-side along the peripheral edge of the second substrate surface 61b, and the two pin-connection electrodes 18 are arranged on an inner side relative to the seven pin-connection electrodes 17 (on the center side of the connection substrate section 61).

In addition, plural (two in the present embodiment) notches 611 are formed on the connection substrate section 61 at a portion of the outer circumferential edge and two pins 411 respectively penetrate through the notches 611. The two pins 411 are connected to the insulated wires 23 (see FIG. 2).

As shown in FIG. 8, on the positioning section 62, plural (nine in the present embodiment) notches are formed at the outer circumferential edge and plural (two in the present embodiment) through-holes 622 are formed on an inner side relative to the plural notches (on the center side of the positioning section 62). The two pins 42 for high speed signal line respectively penetrate through the through-holes 622.

### Connection Structure of Plural Pins 4, Circuit Substrate 5 and Connection Member 6

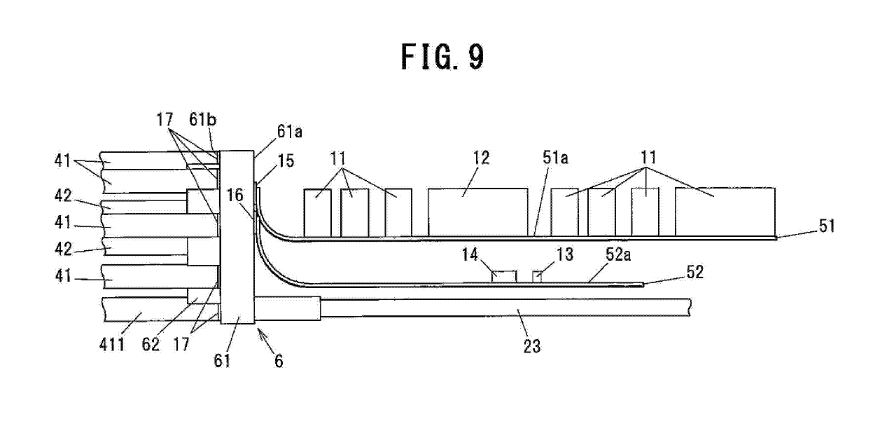

Next, a connection structure between the plural pins 4 and the circuit substrate 5 and a connection structure between the circuit substrate 5 and the connection member 6 will be described in reference to FIG. 9.

FIG. 9 is a side view showing connection between the plural pins 4 and the connection member 6 and between the circuit substrate 5 and the connection member 6. Note that, FIG. 9 only shows the pins 41, 42 to be connected to the connection substrate section 61 of the connection member 6 and the pins 411 penetrating through the connection substrate section 61, and the illustration of other pins 4 is omitted.

The connection substrate section 61 has the first substrate surface 61a along a direction crossing a portion of the mounting surfaces 51a and 52a of the electric circuit board 51 and the optical circuit board 52 on which the electric circuit components 11 and 12 and the optical circuit components 13 and 14 (the photoelectric conversion element 13 and the semiconductor circuit element 14) are arranged. The electric circuit board 51 and the optical circuit board 52 are each formed of a flexible board and are electrically connected to the plural substrate-connection electrodes 15 and 16 provided on the first substrate surface 61a of the connection substrate section 61 in a state that the respective edges on one side are bent.

In more detail, plural electrodes formed on a surface of the electric circuit board 51 opposite to the mounting surface 51a are soldered to the plural substrate-connection electrodes 15, and plural electrodes formed on a surface of the optical circuit board 52 opposite to the mounting surface 52a are soldered to the plural substrate-connection electrodes 16. For connecting the plural electrodes on the electric circuit board 51 and the optical circuit board 52 to the plural substrate-connection electrodes 15 and 16 on the connection substrate section 61, the connection method is not limited to the soldering and may be, e.g., welding.

The plural pins 41 and 42 penetrate through the positioning section 62 and are respectively electrically connected to the plural pin-connection electrodes 17 and 18 in a state that end surfaces on one side face the second substrate surface 61b of the connection substrate section 61. In more detail, the plural pins 41 and 42 are in contact with the plural pin-connection electrodes 17 and 18 at one end surface and are connected thereto by, e.g., soldering.

As a result, the plural pins 41 and 42 are electrically connected to the connection substrate section 61, the circuit substrate 5 is electrically connected to the connection substrate section 61, and the plural pins 41 and 42 are thus electrically connected to the circuit substrate 5. In other words, the plural pins 41 and 42 are electrically connected to the circuit substrate 5 via the connection substrate section 61.

### Functions and Effects of the Embodiment

The following functions and effects are obtained in the embodiment described above.

(1) The plural pins 41 and 42 can be positioned relative to the connection substrate section 61 by penetrating though the positioning section 62, and thus can be easily connected to the plural pin-connection electrodes 17 and 18 as connection points provided on the connection substrate section 61.

(2) The axial direction of the plural pins 41 and 42 is a direction orthogonal to the second substrate surface 61b of the connection substrate section 61, and the electric circuit board 51 and the optical circuit board 52 are arranged so that the mounting surfaces 51a and 52a are along a direction crossing the first substrate surface 61a of the connection substrate section 61. Therefore, it is possible to provide a space for accommodating electronic components even when the connector 10 is small.

(3) The electric circuit board 51 and the optical circuit board 52, which are formed of elastically deformable flexible boards having flexibility and are pressed against the substrate surface 61a of the connection substrate section 61 in a state that one end portion is bent, are easily connected to the connection substrate section 61 and, for example, even when an impact is applied to the connector 10, the impact is absorbed and this allows the connection state of the electric circuit board 51 and the optical circuit board 52 to the connection substrate section 61 to be maintained.

(4) Since the electric circuit board 51 and the optical circuit board 52 are arranged so that the mounting surfaces 51a and 52a are parallel to each other, it is possible to provide a sufficient mounting space for mounting electronic components.

(5) The positioning section 62 has the plural through-holes 622 arranged on the inner side relative to the plural notches 621 formed at the outer circumferential edge, and the pins 42 for high speed signal line penetrate through the through-holes 622. Therefore, it is less likely to be affected by external noise, allowing high-speed communication with high accuracy.

(6) Since the circuit substrate 5 and the plural pins 41 and 42 are connected to the substrate-connection electrodes 15 and 16 and the pin-connection electrodes 17 and 18 respectively provided on the first and second substrate surfaces 61a and 61b of the connection substrate section 61, a size of the connector 10 in the extending direction of the cable 2 is smaller than when, e.g., providing a connecting receptacle on the connection substrate section 61, leading to a downsizing of the connector 10.

### Summary of the Embodiment

Technical ideas understood from the embodiment will be described below citing the reference numerals, etc., used for the embodiment. However, each reference numeral, etc., described below is not intended to limit the constituent elements in the claims to the members, etc., specifically described in the embodiment.

[1] A connector (10), comprising: a plurality of pins (4); a circuit substrate (5) where an electronic component(s) is mounted on a mounting surface; a connection member (6) for electrically connecting the plurality of pins (4) and the circuit substrate (5); and a housing (3) for accommodating the circuit substrate (5) and the connecting member (6), wherein the connection member (6) comprises a connection substrate section (61) including a first substrate surface (61a) to which one end part of the circuit substrate (5) is connected and a positioning section (62) for positioning the plurality of pins (4) relative to a second substrate surface (61b) of the connection substrate section (61) provided on the opposite side of the first substrate surface (61a), and the plurality of pins (4) penetrate through the positioning section (62) and are thereby electrically connected in a state where one end surface of each of the plurality of pins (4) faces the second substrate surface (61b) of the connection substrate section (61).

[2] The connector defined by [1], wherein an axial direction of the plurality of pins (4) is a direction orthogonal to the second substrate surface (61b) of the connection substrate section (61), and the mounting surface of the circuit substrate (5) is arranged in a direction crossing the first substrate surface (61a) of the connection substrate section (61).

[3] The connector (10) defined by [1] or [2], wherein the circuit substrate (5) comprises a flexible board, and one end part of the circuit substrate (5) is bent and is electrically connected to the first substrate surface (61a) of the connection substrate section (61).

[4] The connector (10) defined by any one of [1] to [3], wherein electric circuit components (11, 12) and optical circuit components (photoelectric conversion element 13, semiconductor circuit element 14) are mounted as the electronic component on the circuit substrate (5).

[5] The connector (10) defined by [4], wherein the circuit substrate (5) comprises an electric circuit board (51) mounting the electric circuit components (11, 12) and an optical circuit board (52) mounting the optical circuit components (photoelectric conversion element 13, semiconductor circuit element 14), and the electric circuit board (51) and the optical circuit board (52) are arranged so that the respective mounting surfaces (51a, 52a) thereof are parallel to each other.

[6] The connector (10) defined by any one of [1] to [5], wherein the positioning section (62) comprises a plurality of notches (621) formed at an outer circumferential edge and a plurality of through-holes (622) formed on the inner side relative to the plurality of notches (621), and pins (42) for high speed signal line among the plurality of pins (4) penetrate through the plurality of through-holes (622).

[7] The connector (10) defined by any one of [1] to [6], wherein the plurality of pins (4) and the circuit substrate (5) are connected to electrodes (15 to 18) respectively provided on the first and second substrate surfaces (61a, 61b) of the connection substrate section (61).

[8] A cable with connector (1), comprising: the connector (10) described in any of the [1] to [7], and a cable (2) that comprises an electric wire(s) (insulated wire 23) comprising a conductor (23a) connected to a pin (4) among at least some of the plurality of pins (4) and a sheath (26) covering the insulated wire(s) (23).

Although the embodiment of the invention has been described, the invention according to claims is not to be limited to the embodiment described above. Further, please note that all combinations of the features described in the embodiment are not necessary to solve the problem of the invention.

The invention can be appropriately modified and implemented without departing from the gist thereof. For example, although a photoelectric composite connector and a photoelectric composite connectorized cable, which mount electric circuit components and optical circuit components, have been described in the embodiment, it is not limited thereto. For example, only electric circuit components may be mounted and the intended use of the connector 10 and the cable with connector 1 is not limited.

In addition, although the connector 10 has a cylindrical shape in the embodiment, it is not limited thereto. The connector 10 may have, e.g., a squared cylindrical shape.

In addition, the numbers of the plural pins 4 and the insulated wires 23 are not specifically limited and can be changed according to the intended used of the connector 10 and the cable with connector 1.

In addition, the circuit substrate 5 is composed of two substrates, the electric circuit board 51 and the optical circuit board 52, in the embodiment, it is not limited thereto. The number of the substrates can be changed according to the intended used of the connector 10 and the cable with connector 1.

In addition, although the plural notches 611 and 621 are formed at a portion of the outer circumferential edge of the connection substrate section 61 and at the outer circumferential edge of the positioning section 62 in the embodiment, it is not limited thereto. For example, through-holes may be formed instead.

### REFERENCE SIGNS LIST

1: CABLE WITH CONNECTOR
2: CABLE
3: HOUSING
4, 41, 42, 411: PIN
5: CIRCUIT SUBSTRATE
6: CONNECTION MEMBER
10: CONNECTOR
11, 12: ELECTRIC CIRCUIT COMPONENT
13: PHOTOELECTRIC CONVERSION ELEMENT (OPTICAL CIRCUIT COMPONENT)
14: SEMICONDUCTOR CIRCUIT ELEMENT (OPTICAL CIRCUIT COMPONENT)
15, 16: SUBSTRATE-CONNECTION ELECTRODE
17, 18: PIN-CONNECTION ELECTRODE
23a: CONDUCTOR
26: SHEATH
51: ELECTRIC CIRCUIT BOARD
51a, 52a: MOUNTING SURFACE
52: OPTICAL CIRCUIT BOARD
61: CONNECTION SUBSTRATE SECTION
61a, 61b: FIRST AND SECOND SUBSTRATE SURFACES
62: POSITIONING SECTION

1. A connector, comprising:
a plurality of pins;
a circuit substrate where an electronic component is mounted on a mounting surface;
a connection member for electrically connecting the plurality of pins and the circuit substrate; and
a housing for accommodating the circuit substrate and the connecting member,
wherein the connection member comprises a connection substrate section including a first substrate surface to which one end part of the circuit substrate is connected and a positioning section for positioning the plurality of pins relative to a second substrate surface of the connection substrate section provided on the opposite side of the first substrate surface, and the plurality of pins penetrate through the positioning section and are thereby electrically connected in a state where one end surface of each of the plurality of pins faces the second substrate surface of the connection substrate section.

2. The connector according to claim 1, wherein an axial direction of the plurality of pins is a direction orthogonal to the second substrate surface of the connection substrate section, and the mounting surface of the circuit substrate is arranged in a direction crossing the first substrate surface of the connection substrate section.

3. The connector according to claim 1, wherein the circuit substrate comprises a flexible board, and one end part of the circuit substrate is bent and is electrically connected to the first substrate surface of the connection substrate section.

4. The connector according to claim 1 , wherein electric circuit components and optical circuit components are mounted as the electronic component on the circuit substrate.

5. The connector according to claim 4, wherein the circuit substrate comprises an electric circuit board mounting the electric circuit components and an optical circuit board mounting the optical circuit components, and the electric circuit board and the optical circuit board are arranged so that the respective mounting surfaces thereof are parallel to each other.

6. The connector according to claim 1, wherein the positioning section comprises a plurality of notches formed at an outer circumferential edge and a plurality of through-holes formed on the inner side relative to the plurality of notches, and pins for high speed signal line among the plurality of pins penetrate through the plurality of through-holes.

7. The connector according to claim 1, wherein the plurality of pins and the circuit substrate are connected to electrodes respectively provided on the first and second substrate surfaces of the connection substrate section.

8. A cable with connector, comprising:
the connector according to claim 1, and
a cable that comprises an electric wire comprising a conductor connected to a pin among at least some of the plurality of pins and a sheath covering the electric wire.
